(19) United States
(12) Patent Application Publication
(10) Pub. No.: US 2013/0223749 A1
(43) Pub. Date: Aug. 29, 2013

(54) IMAGE RECOGNITION APPARATUS AND METHOD USING SCALABLE COMPACT LOCAL DESCRIPTOR

(71) Applicant: Electronics and Telecommunications Research Institute, (US)

(72) Inventors: Sang-Il NA, Daejeon (KR); Keun-Dong Lee, Daejeon (KR); Weon-Geun OH, Daejeon (KR); Hyuk Jeong, Daejeon (KR); Sung-Kwan Je, Daejeon (KR); Dong-Seok Jeong, Seoul (KR)

(73) Assignee: Electronics and Telecommunications Research Institute, Daejeon (KR)

(21) Appl. No.: 13/781,670

(22) Filed: Feb. 28, 2013

(30) Foreign Application Priority Data
Feb. 28, 2012 (KR) 10-2012-0020558

(51) Int. Cl. G06K 9/46; G06K 9/62

(52) U.S. Cl. CPC G06K 9/46; G06K 9/6201
USPC 382/201; 382/195

(57) ABSTRACT

An image recognition apparatus using a scalable compact local feature descriptor is provided. The image recognition apparatus includes a feature descriptor generator, a database, and a descriptor matcher. The feature descriptor generator extracts scalable compact local feature descriptor information for recognizing an object from input image information. The database includes information on a plurality of feature descriptors. The descriptor matcher compares a feature descriptor output from the feature descriptor generator with a plurality of feature descriptors stored in the database to recognize an object included in an image.

### CROSS-REFERENCE TO RELATED APPLICATION

This application claims the benefit under 35 U.S.C. §119(a) of a Korean Patent Application No. 10-2012-0020558, filed on Feb. 28, 2012, the entire disclosure of which is incorporated herein by reference for all purposes.

### BACKGROUND

1. Field

The following description relates to image processing technology, and more particularly, to an apparatus and a method for recognizing an object included in an image using a feature descriptor extracted from a specific region of the image.

2. Description of the Related Art

In a method of describing the feature of an image, there are a global descriptor that represents all characteristics of an image using one vector, and a local descriptor that compares different regions of an image to extract a plurality of regions having distinct characteristics from the image, and represents all characteristics of the image using a plurality of vectors for the respective regions.

The local descriptor is based on a local description, and thus is capable of generating the same description for the same region in spite of geometric changes in an image. Therefore, when using the local description, the local descriptor recognizes and extracts an object included in an image without preprocessing such as image segmentation, and particularly, even when a portion of an image is covered, the local descriptor can strongly respond to the case in representing the feature of the image.

Due to such advantages, the local descriptor is being widely used in pattern recognition, computer vision, and computer graphic fields, including, for example, object recognition, image retrieval, panorama generation, etc.

An operation of calculating the local descriptor is largely categorized into two stages. A first stage is a stage of extracting a point having characteristic differentiated from peripheral pixels as a feature point. A second stage is a stage of calculating a descriptor using the extracted feature point and peripheral pixel values.

Technology for generating a feature descriptor on the basis of the above-described local region information and matching the feature descriptor with a local feature descriptor of a different image is applied to various computer vision fields such as content-based image/video retrieval, object recognition and detection, video tracking, and augmented reality.

Recently, due to the introduction of mobile devices, the amount of distributed multimedia content is explosively increasing, and it is becoming easier to obtain content. Therefore, the demand for computer vision-related technology associated with object recognition for effectively retrieving the content is increasing. Especially, due to the characteristics of smart phones in which it is inconvenient to input letters, the necessity of content-based image retrieval technology that performs retrieval by inputting an image is increasing, and a retrieval application using the existing feature-based image processing technology is being actively created.

Representatives of the local feature-based image processing technology using the feature point include SIFT and SURF. Such technology is used to extract a point in which a change in a pixel statistical value is large as in a corner as a feature point from a scale space, and extract a feature descriptor using a relationship between the extracted point and a peripheral region.

However, since the size of a local feature descriptor is very large, a case in which the descriptor size of an entire image is greater than the compression size of an image occurs very frequently. For this reason, only a descriptor having a large capacity is extracted even when a simple feature descriptor is required, and thus, a large-capacity memory is used to store a descriptor.

### SUMMARY

The following description relates to an apparatus and a method for extracting and matching a scalable feature descriptor having scalability according to a purpose and an environment to which technology of extracting a feature descriptor is applied.

In one general aspect, an image recognition apparatus includes: a feature descriptor generator configured to extract scalable compact local feature descriptor information for recognizing an object from input image information; a database configured to include information on a plurality of feature descriptors; and a descriptor matcher configured to compare a feature descriptor output from the feature descriptor generator with a plurality of feature descriptors stored in the database to recognize an object included in an image.

In another general aspect, an image recognition method using a scalable local feature descriptor in an image recognition apparatus includes: extracting a scalable compact local feature descriptor from an input image; and retrieving a feature descriptor similar to the extracted feature descriptor to match the feature descriptors.

Other features and aspects will be apparent from the following detailed description, the drawings, and the claims.

### BRIEF DESCRIPTION OF THE DRAWINGS

FIG. 1 is a block diagram illustrating an image recognition apparatus according to an embodiment of the present invention.

FIG. 2 is a detailed block diagram illustrating a feature descriptor generator according to an embodiment of the present invention.

FIG. 3 is a diagram illustrating an image compared by a feature comparison unit.

FIG. 4 is a detailed block diagram illustrating a feature descriptor matcher according to an embodiment of the present invention.

FIG. 5 is a flowchart for describing a feature descriptor extracting method according to an embodiment of the present invention.

FIG. 6 is a flowchart for describing in detail an operation of calculating a local region feature according to an embodiment of the present invention.

FIG. 7 is a flowchart for describing a feature descriptor matching method according to an embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

Hereinafter, embodiments of the present invention will be described in detail with reference to the accompanying drawings.

The present invention relates to image recognition technology for detecting which object is included in an image, and particularly, provides an object recognition apparatus and method using a scalable compact local feature descriptor. Also, in the present invention, the image recognition apparatus should be construed as being applicable to all devices that recognize an object included in an image and output information on what the recognized object is, such as mobile communication terminals including personal digital assistants (PDAs), smart phones, navigation terminals, etc., as well as personal computers (PCs) including desktop computers, notebook computers, etc.

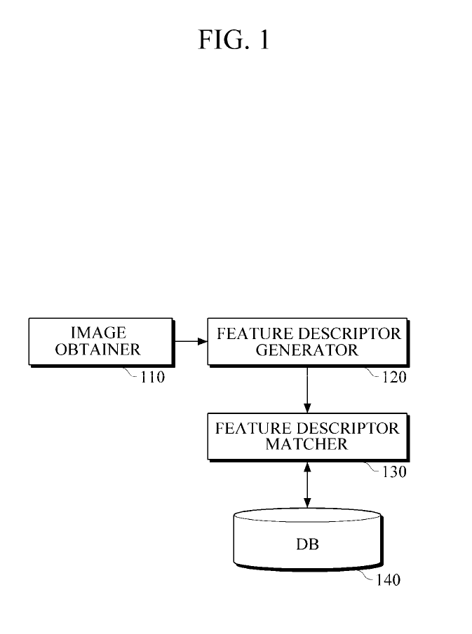

FIG. 1 is a block diagram illustrating an image recognition apparatus using a scalable compact local feature descriptor according to an embodiment of the present invention.

Referring to FIG. 1, the image recognition apparatus using a scalable compact local feature descriptor according to an embodiment of the present invention (hereinafter referred to as an image recognition apparatus) includes an image obtainer 110, a feature descriptor generator 120, a feature descriptor matcher 130, and a database (DB) 140.

The image obtainer 110 is a means of obtaining an image and outputting the image to the feature descriptor generator 120, and for example, may be a camera or an image sensor. Also, in an additional aspect of the present invention, the image obtainer 110 may be a camera that enlarges or reduces an image, and is capable of rotating automatically or manually. Moreover, the image obtainer 110 may obtain and output an image that has been previously captured through a communication interface, or obtain and output an image that is stored in a memory.

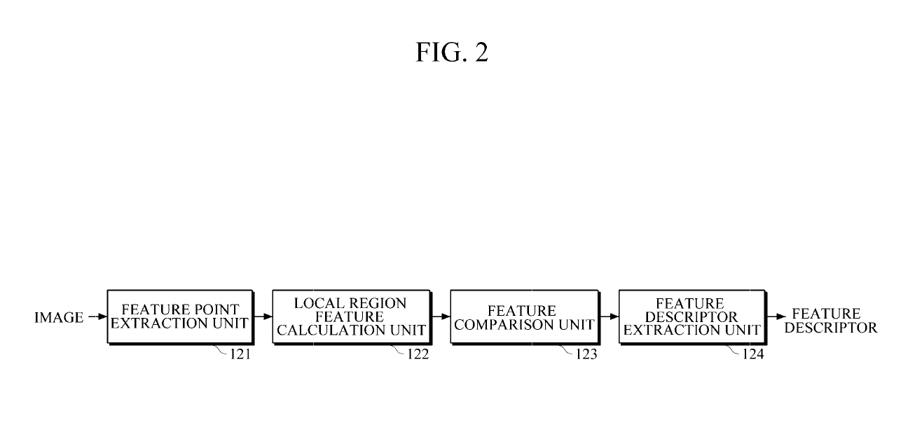

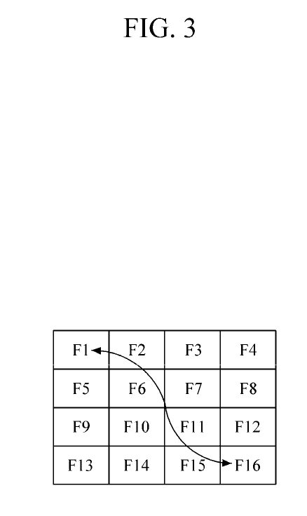

The feature descriptor generator 120 extracts feature information for recognizing an object from an image that is input through the image obtainer 110. The feature descriptor generator 120 will be described below with reference to FIGS. 2 and 3 in detail.

The feature descriptor matcher 130 compares a feature descriptor that is output from the feature descriptor generator 120 with feature descriptors that are previously stored in the database 140, and matches the compared feature descriptors. The feature descriptor 130 determines what an object included in an image is through the matching.

The database 140 stores feature descriptor information of a pre-designated object for determining what an object recognized from image information is. That is, a feature descriptor of an object called “Mega Box” is previously stored, and the feature descriptor of the object called “Mega Box” is retrieved as a feature descriptor similar to a feature descriptor of an object included in an image, whereupon the feature descriptor matcher 140 may determine the object included in the image as a book when the feature descriptors are capable of being matched.

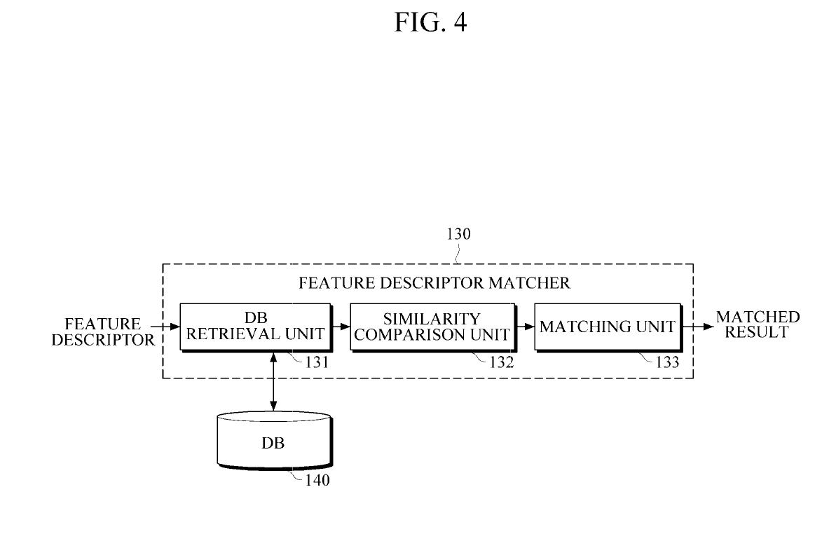

The feature descriptor matcher 130 retrieves a feature descriptor similar to feature descriptors output from the feature descriptor generator 120 from the database 140, compares the feature descriptors, and outputs matching result information that is obtained by matching the feature descriptors according to the compared result. The feature descriptor matcher 130 will be described below with reference to FIG. 4 in detail.

FIG. 2 is a detailed block diagram illustrating the feature descriptor generator according to an embodiment of the present invention.

Referring to FIG. 2, the feature descriptor generator 120 includes a feature point extraction unit 121, a local region feature calculation unit 122, a feature comparison unit 123, and a feature descriptor extraction unit 124.

The feature point extraction unit 121 extracts a point at which the change in a pixel statistical value is large as in a corner as a feature point from a scale space of an image that is input through the image obtainer 110. The feature point extraction unit 121 calculates the scale of the extracted feature point to extract a local region. In this case, the extracted local region is extracted in consideration of orientation, and may have various shapes such as a tetragon, a circle, etc. According to an embodiment of the present invention, a fast-Hessian detector may be used in a method of calculating a scale and an orientation angle.

The local region feature calculation unit 122 extracts information for a feature description of the local region that is extracted by the feature point extraction unit 121. The extracted information is used by segmenting the local region into specific shapes such as a tetragon, a circle, etc. A statistical value calculated in each region is calculated as a one-dimensional statistical value such as an average and a variance, a two-dimensional statistical value, and a high-dimensional statistical value such as a saliency map and the number of corners that are extracted from each region. is The feature comparison unit 123 compares features calculated by the local region feature calculation unit 122 for each region, and generates a bit stream that is used in an actual feature descriptor. In this case, a method of binarizing a feature value by comparing the sizes of feature values between different blocks, and a method of quantizing a feature value by aligning a plurality of feature values may be used for the comparison. FIG. 3 is a diagram illustrating an example in which a feature value is binarized through comparison between blocks.

Referring to FIG. 3, a local region of an image forms sixteen segmented blocks. In this case, the feature comparison unit 123 compares a block “F1” and a block “F16,” and according to the compared result, the feature comparison unit 123 designates 1 to a block having a large feature value and designates 0 to a block having a small feature value. The feature comparison unit 123 compares a block “F2” and a block “F15,” and according to the compared result, the feature comparison unit 123 designates 1 to a block having a large feature value and designates 0 to a block having a small feature value. The feature comparison unit 123 compares feature values of two paired blocks among the segmented blocks, and binarizes the feature values. At this point, the feature comparison unit 123 stores only one of the binarized values, namely, one of 1 and 0.

As another method, a method of storing ranking of the sizes of values of a block “F1” to a block “F16” may be used. That is, by comparing the sizes of feature values of the block “F1” to the block “F16,” the method includes designating values of 1 to 16 in the order of size, and storing a designated value for each of the blocks.

The feature descriptor extraction unit 124 generates a descriptor using a local region feature result value that is obtained from the feature comparison unit 123. The generated descriptor includes information on a position, scale, and angle of the extracted region, and configures a descriptor by adding a region feature comparison value. In this case, depending on the case, the feature descriptor extraction unit 124 may adjust the scale of the descriptor by cutting a portion of a comparison bit stream of the descriptor.

FIG. 4 is a detailed block diagram illustrating the feature descriptor matcher according to an embodiment of the present invention.

Referring to FIG. 4, the feature descriptor matcher 130 includes a DB retrieval unit 131, a similarity comparison unit 132, and a matching unit 133.

The DB retrieval unit 131 retrieves the database 140 according to the input of a feature descriptor from the feature descriptor generator 120. That is, the DB retrieval unit 131 retrieves one or more feature descriptors similar to the input feature descriptor from the database 140.

The similarity comparison unit 132 compares similarities between the one or more feature descriptors retrieved by the DB retrieval unit 131 and the feature descriptors input from the feature descriptor generator 120.

When the similarities compared by the similarity comparison unit 132 satisfy a predetermined threshold value and other conditions, the matching unit 133 determines two feature descriptors as matching. The number of similarities is plural according to the number and statistical values of block-converted patches included in a feature descriptor, and thus, matching can be efficiently performed based on various combined similarities. That is, the matching unit 133 determines what a corresponding object is.

Next, an image recognition method using a scalable compact region feature descriptor will be described.

The image recognition method according to an embodiment of the present invention includes an operation of extracting a scalable compact region feature descriptor from an input image, and an operation of retrieving a feature descriptor similar to the extracted scalable compact region feature descriptor and matching the retrieved feature descriptor with the extracted feature descriptor.

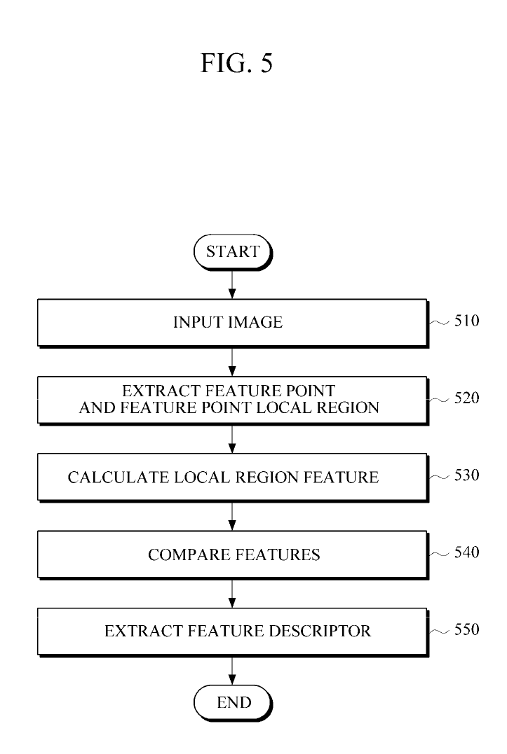

FIG. 5 is a flowchart for describing a feature descriptor extracting method according to an embodiment of the present invention.

Referring to FIG. 5, the feature descriptor generator 120 receives an image in operation 510. Therefore, the feature descriptor generator 120 extracts a point at which the change in a pixel statistical value is large as in a corner as a feature point from a scale space of the received image, and calculates the scale of the extracted feature point to extract a local region in operation 520. In this case, the extracted local region is extracted in consideration of orientation, and may have various shapes such as a tetragon, a circle, etc. According to an embodiment of the present invention, a fast-Hessian detector may be used in a method of calculating a scale and an orientation angle.

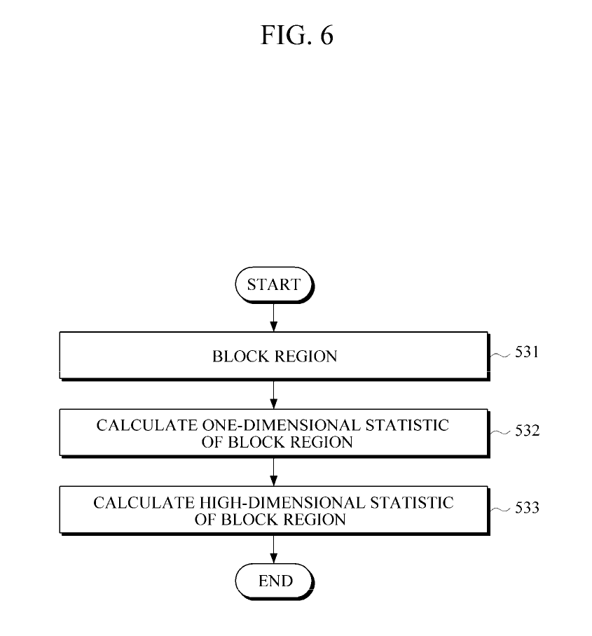

The feature descriptor generator 120 extracts information for a feature description of the extracted local region in operation 530. This will be described in detail with reference to FIG. 6.

FIG. 6 is a flowchart for describing in detail an operation of calculating a local region feature according to an embodiment of the present invention.

Referring to FIG. 6, the feature descriptor generator 120 performs block conversion on a local region in operation 531. That is, the local region is segmented into specific shapes such as a tetragon, a circle, etc. and used.

In statistical values calculated in each block, the feature descriptor generator 120 calculates a one-dimensional statistical value such as an average and a variance in operation 532, and calculates a two-dimensional statistical value and a high-dimensional statistical value such as a saliency map and the number of corners that are extracted from each region in operation 533.

The feature descriptor generator 120 compares features calculated by the local region feature calculation unit 122 for each region, and generates a bit stream that is used in an actual feature descriptor in operation 540. In this case, a method of binarizing a feature value by comparing the sizes of feature values between different blocks, and a method of quantizing a feature value by aligning a plurality of feature values may be used for the comparison.

The feature descriptor generator 120 generates a descriptor using a local region feature result value in operation 550. The generated descriptor includes information on a position, scale, and angle of the extracted region, and configures a descriptor by adding a region feature comparison value. In this case, depending on the case, the feature descriptor generator 120 may adjust the scale of the descriptor by cutting a portion of a comparison bit stream of the descriptor.

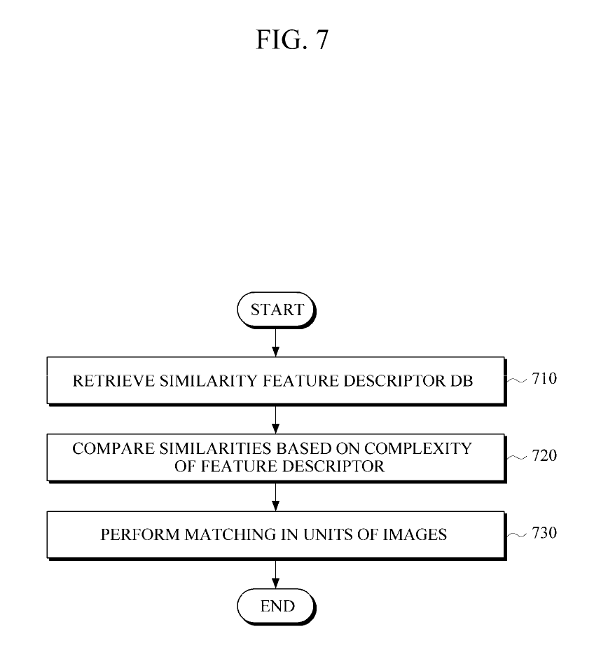

FIG. 7 is a flowchart for describing a feature descriptor matching method according to an embodiment of the present invention.

Referring to FIG. 7, a feature descriptor is input, and thus, the feature descriptor matcher 130 retrieves one or more feature descriptors similar to the input feature descriptor from the database 140 in operation 710.

The feature descriptor matcher 130 compares similarities between the retrieved one or more feature descriptors and the input feature descriptors in operation 720.

When the compared similarities satisfy a predetermined threshold value and other conditions, the feature descriptor matcher 130 determines two feature descriptors as matching in operation 730. The number of similarities is plural according to the number and statistical values of block-converted patches included in a feature descriptor, and thus, matching can be efficiently performed based on various combined similarities. That is, the feature descriptor matcher 130 determines what a corresponding object is.

According to the present invention, a scalable feature descriptor that changes the size of a descriptor and a processing speed according to an applied purpose can be generated.

Accordingly, according to the present invention, different descriptors can be extracted according to a descriptor storage space and the performance of an extractor, and moreover, the extracted descriptors having different sizes can be matched.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An image recognition apparatus, comprising:
a feature descriptor generator configured to extract scalable compact local feature descriptor information for recognizing an object from input image information;
a database configured to include information on a plurality of feature descriptors; and
a descriptor matcher configured to compare a feature descriptor output from the feature descriptor generator with a plurality of feature descriptors stored in the database to recognize an object included in an image.

2. The image recognition apparatus of claim 1, wherein the feature descriptor generator comprises:
a feature point extraction unit configured to extract a point at which a change in a pixel statistical value is large as a feature point from a scale space of the input image;
is a local region feature calculation unit configured to calculate a scale of the feature point to extract a local region;
a feature comparison unit configured to compare features calculated by the local region feature calculation unit for each region to generate a bit stream which is used in an actual feature descriptor; and
a feature descriptor extraction unit configured to generate a descriptor using a local region feature result value output from the feature comparison unit.

3. The image recognition apparatus of claim 2, wherein the local region feature calculation unit segments the local region extracted by the local region feature calculation unit into a plurality of blocks having a specific shape including a tetragon or a circle, and calculates a statistical value of each of the blocks.

4. The image recognition apparatus of claim 2, wherein the comparison unit compares sizes of feature values of paired blocks, and binarizes the feature values according to the compared result.

5. The image recognition apparatus of claim 4, wherein the comparison unit stores one of the binarized values of 1 and 0.

6. The image recognition apparatus of claim 2, wherein the comparison unit aligns and quantizes the feature values of the blocks according to sizes.

7. The image recognition apparatus of claim 2, wherein the feature descriptor comprises information on a position, scale, and angle of the extracted region, and a region feature comparison value is added to the feature descriptor.

8. The image recognition apparatus of claim 2, wherein the feature descriptor extraction unit adjusts a scale of a descriptor by cutting a portion of a bit stream of the descriptor depending on the case.

9. The image recognition apparatus of claim 1, wherein the feature descriptor matcher comprises:
a database retrieval unit configured to retrieve one or more feature descriptors similar to a feature descriptor from the database according to input of the feature descriptor from the feature descriptor generator;
a similarity comparison unit configured to compare similarities between the one or more feature descriptors retrieved by the database retrieval unit and feature descriptors input from the feature descriptor generator; and
a matching unit configured to determine two feature descriptors as matching when the similarities compared by the similarity comparison unit satisfy a predetermined threshold value and other conditions.

10. An image recognition method using a scalable local feature descriptor in an image recognition apparatus, the image recognition method comprising:
extracting a scalable compact local feature descriptor from an input image; and
retrieving a feature descriptor similar to the extracted feature descriptor to match the feature descriptors.

11. The image recognition method of claim 10, wherein the extracting of the scalable compact local feature descriptor comprises:
extracting a point at which a change in a pixel statistical value is large as a feature point from a scale space of the input image;
calculating a scale of the feature point to extract a local region;
extracting information for a feature description of the extracted local region;
comparing the calculated features by region to generate a bit stream which is used in an actual feature descriptor; and
generating a descriptor using a local region feature result value.

12. The image recognition method of claim 11, wherein the extracting of the information for a feature description of the extracted local region comprises:
block-converting the local region;
calculating a one-dimensional statistical value as a statistical value calculated in each of a plurality of regions, the one-dimensional statistical value including an average and a variance; and
calculating a high-dimensional statistical value including a saliency map and the number of corners which are extracted from each region.

13. The image recognition method of claim 10, wherein the matching of the feature descriptors comprises:
retrieving one or more feature descriptors similar to a feature descriptor according to input of the feature descriptor;
comparing similarities between the retrieved one or more feature descriptors and input feature descriptors; and
determining two feature descriptors as matching, when the compared similarities satisfy a predetermined threshold value and other conditions.
